(19) United States
(12) Patent Application Publication
(10) Pub. No.: US 2020/0032008 A1
(43) Pub. Date: Jan. 30, 2020

(54) METHOD FOR PRODUCING RUBBER WET MASTERBATCH, AND METHOD FOR PRODUCING RUBBER COMPOSITION

(71) Applicant: Toyo Tire Corporation, Itami-shi (JP)

(72) Inventors: Akihito Mitsui, Itami-shi (JP); Makoto Tanaka, Itami-shi (JP)

(73) Assignee: Toyo Tire Corporation, Itami-shi (JP)

(21) Appl. No.: 16/521,878

(22) Filed: Jul. 25, 2019

(30) Foreign Application Priority Data
Jul. 30, 2018 (JP) 2018-142342
Jul. 30, 2018 (JP) 2018-142346
Jul. 30, 2018 (JP) 2018-142347

(51) Int. Cl. C08J 3/21; C08J 3/22; C08K 3/04; C08L 7/02; B60C 1/00; B60C 11/00

(52) U.S. Cl. CPC C08J 3/212; C08J 3/226; C08K 3/04; C08K 2201/005; B60C 1/0016; B60C 11/0008; B60C 1/0041; C08L 7/02

(57) ABSTRACT

A method for producing a rubber wet masterbatch is disclosed including mixing a carbon-black-containing aqueous-slurry-solution in which a carbon black is dispersed in water with a rubber latex solution to produce a carbon-black-containing aqueous-rubber-latex-solution, solidifying the resultant carbon-black-containing aqueous-rubber-latex-solution to produce a carbon-black-containing rubber solidified product, and dehydrating and drying the resultant carbon-black-containing rubber solidified product to produce a rubber wet masterbatch. In this method, about the carbon-black-containing aqueous-slurry-solution, in carbon black particles in the slurry-solution, the proportion of carbon black particles having a particle diameter of 60 μm or more is 35% or less by volume. The particle diameter is based on a measurement of the carbon black particles in the slurry-solution with an image-analytic particle size distribution meter. The method for producing a rubber wet masterbatch can give a vulcanized rubber having excellent abrasion resistance while the rubber has a low exothermicity.

### BACKGROUND OF THE INVENTION

### Field of the Invention

The present invention relates to a method for producing a rubber wet masterbatch, and a method for producing a rubber composition.

### Description of the Related Art

It has been hitherto known in the rubber industry that when a rubber composition containing a carbon black is produced, a rubber wet masterbatch is used to improve the workability of the composition and the dispersibility of the carbon black therein. This technique is a technique of mixing a carbon black and a dispersing solvent beforehand with each other at a predetermined ratio, dispersing the carbon black into the dispersing solvent by a mechanical force, mixing the resultant carbon-black-containing slurry solution with a rubber latex solution in a liquid phase, adding a solidifier such as an acid, after the mixing, to the mixture to solidify the mixture, collecting the solidified mixture (carbon-black-containing rubber solidified product), and then drying the mixture.

The use of a rubber wet masterbatch gives a rubber composition better in dispersibility of a carbon black therein and better in rubber physical properties, such as workability and reinforceability, than the use of a rubber dry masterbatch yielded by mixing a carbon black and a rubber with each other in a solid phase. The use of such a rubber composition as a raw material makes it possible to produce a rubber product (vulcanized rubber), for example, for pneumatic tires decreased in rolling resistance and excellent in fatigue resistance.

Patent Document 1 discloses a method for producing a rubber wet masterbatch, in which at the time of dispersing a carbon black into a dispersing solvent, a portion of a rubber latex solution is added to this dispersing system to cause a very thin latex layer to adhere onto the surface of the carbon black in order to prevent the carbon black contained in a carbon-black-containing slurry solution from re-aggregating. In a carbon-black-containing rubber latex solution yielded by such a method, in which rubber latex particles adhere to a carbon black, the carbon black can be restrained from re-aggregating when this rubber latex solution is treated in solidifying and drying steps. Consequently, the carbon black can be evenly dispersed in the resultant rubber wet masterbatch, so that a vulcanized rubber yielded using this rubber wet masterbatch is excellent in exothermicity, endurance, and rubber strength.

### PRIOR ART DOCUMENT

### Patent Document

Patent Document 1: JP-A-2012-144680

### SUMMARY OF THE INVENTION

Apart from the above, the market requires a tire (vulcanized rubber) yielded using a rubber composition as a raw material to be excellent in abrasion resistance while the tire has a low exothermicity. However, about a vulcanized rubber yielded from a rubber composition as disclosed in Patent Document 1, there remains a room for improving this property.

Moreover, about tires (vulcanized rubbers) each yielded using a rubber composition as a raw material, a vulcanized rubber for tire treads is required to be excellent in abrasion resistance while the vulcanized rubber has a low exothermicity. However, about a vulcanized rubber yielded from a rubber composition as described in Patent Document 1, there remains a room for improving this property.

Furthermore, about tires (vulcanized rubbers) each yielded using a rubber composition as a raw material, a vulcanized rubber for ply topping (rubber for a member for coating cords in a carcass ply or belt ply of a pneumatic tire) is required to be excellent in tear resistance and fatigue resistance. However, about a vulcanized rubber yielded from a rubber composition as described in Patent Document 1, there remains a room for improving the properties.

In the light of the above-mentioned actual situation, the present invention has been made. A first object thereof is to provide a method, for producing a rubber wet masterbatch, that can give a vulcanized rubber having excellent abrasion resistance while the vulcanized rubber has a low exothermicity.

In the light of the above-mentioned situation, the present invention has been made also. A second object thereof is to provide a method, for producing a rubber composition for tire treads, that can give a vulcanized rubber having excellent abrasion resistance while the vulcanized rubber has a low exothermicity.

In the light of the above-mentioned situation, the present invention has been further made. A third object thereof is to provide a method, for producing a rubber composition for ply topping, that can give a vulcanized rubber having excellent tear resistance and fatigue resistance.

The present invention relates to a method for producing a rubber wet masterbatch, including a step (I) of mixing a carbon-black-containing aqueous-slurry-solution in which a carbon black is dispersed in water with a rubber latex solution to produce a carbon-black-containing aqueous-rubber-latex-solution, a step (II) of solidifying the resultant carbon-black-containing aqueous-rubber-latex-solution to produce a carbon-black-containing rubber solidified product, and a step (III) of dehydrating and drying the resultant carbon-black-containing rubber solidified product to produce the rubber wet masterbatch, in which about the carbon-black-containing aqueous-slurry-solution, in carbon black particles in the slurry-solution, a proportion of carbon black particles having a particle diameter of 60 μm or more is 35% or less by volume, the particle diameter being based on a measurement of the carbon black particles in the slurry-solution with an image-analytic particle size distribution meter.

The present invention also relates to a method for producing a rubber composition, including a step (IV) of using the above-mentioned rubber wet masterbatch to attain dry-mixing.

The present invention also relates to the method for producing a rubber composition, which is a method for producing a rubber composition for tire treads.

The present invention also relates to the method for producing a rubber composition, which is a method for producing a rubber composition for ply topping.

About an action mechanism of producing advantageous effects of the methods according to the present invention for producing a rubber wet masterbatch and a rubber composition, respectively, details thereof are partially unclear. However, the mechanism is presumed as described below. However, the invention may not be interpreted with limitation to this action mechanism.

The methods of the present invention for producing a rubber wet masterbatch and a rubber composition, respectively, make use of a carbon-black-containing aqueous-slurry-solution in which the proportion of the carbon black particles having a particle diameter of 60 μm or more is 35% or less by volume, the particle diameter being based on a measurement of particles in the slurry-solution with an image-analytic particle size distribution meter. As described in Patent Document 1, in a method for producing a rubber wet masterbatch, it is effective in order to improve the resultant vulcanized rubber in exothermicity and others to restrain carbon black particles (particle groups) contained in a carbon-black-containing aqueous-slurry-solution from aggregating. As described above, in the carbon-black-containing aqueous-slurry-solution in the present invention, the proportion of the carbon black particles having a size not less than the predetermined size is restrained into the predetermined percentage or less by volume. Thus, it is presumed that even if the carbon black particles aggregate, the use of the aqueous-slurry-solution in the invention makes the aggregate smaller in size (or makes the carbon black better in dispersibility in the rubber wet masterbatch) than the use of conventional carbon-black-containing aqueous-slurry-solutions. Thus, a vulcanized rubber yielded using this rubber wet masterbatch has a low exothermicity and excellent abrasion resistance, or excellent tear resistance and fatigue resistance. In a laser diffraction particle size distribution meter, calculations are made using a constraint condition such that in the step of calculating a particle size distribution of particles from a light intensity distribution therefrom, the particle size distribution is continuous to some degree. Thus, even if carbon black particles in an aqueous-slurry-solution have a discontinuous particle size distribution, the result may be calculated as a mono-peak-form distribution. Additionally, when a measurement is made about particles large in diameter, that is, particles large in weight, it is difficult to circulate the particles evenly into a measuring unit of the meter. As a result, the particles large in diameter may not be detected for the particle size distribution. Thus, no laser diffraction particle size distribution meter has been able to specify the percentage by volume of carbon black particles which are contained in a carbon-black-containing aqueous-slurry-solution as described above and which have a size not less than a predetermined size.

### DETAILED DESCRIPTION OF THE PREFERRED EMBODIMENTS

### <Method for Producing Rubber Wet Masterbatch>

The method of the present invention for producing a rubber wet masterbatch, includes a step (I) of mixing a carbon-black-containing aqueous-slurry-solution in which a carbon black is dispersed in water with a rubber latex solution to produce a carbon-black-containing aqueous-rubber-latex-solution, a step (II) of solidifying the resultant carbon-black-containing aqueous-rubber-latex-solution to produce a carbon-black-containing rubber solidified product, and a step (III) of dehydrating and drying the resultant carbon-black-containing rubber solidified product to produce the rubber wet masterbatch. In this method, about the carbon-black-containing aqueous-slurry-solution, in carbon black particles in the slurry-solution, a proportion of carbon black particles having a particle diameter of 60 μm or more is 35% or less by volume, the particle diameter being based on a measurement of the carbon black particles in the slurry-solution with an image-analytic particle size distribution meter.

### <Step (I)>

The step (I) in the present invention includes an operation of mixing a carbon-black-containing aqueous-slurry-solution in which carbon black is dispersed in water with a rubber latex solution to produce a carbon-black-containing aqueous-rubber-latex-solution

### <Carbon-Black-Containing Aqueous-Slurry-Solution>

About the carbon-black-containing aqueous-slurry-solution, in carbon black particles in the slurry-solution, the proportion of carbon black particles having a particle diameter of 60 μm or more is 35% or less by volume. This particle diameter is based on a measurement of the carbon black particles in the slurry-solution with an image-analytical particle size distribution meter. The proportion of the carbon black particles having a particle diameter of 60 μm or more is preferably 25% or less by volume, more preferably 15% or less by volume to improve the carbon black in dispersibility in the rubber wet masterbatch to improve the resultant crosslinked rubber in abrasion resistance. The lower limit value of the proportion is not particularly limited to improve the crosslinked rubber in abrasion resistance. When the producibility of the carbon-black-containing aqueous-slurry-solution is considered, the value is, for example, 3% by volume, more preferably 5% by volume. The carbon black particles denote complex particles referred to as the so-called aggregate, or complex particles referred to as the so-called agglomerate. The image-analytical particle size distribution meter (particle size distribution image analyzer) can measure the particle size distribution of the carbon black particles through two-dimensional image data thereon, and may be, for example, a product “IF-3200” manufactured by JASCO International Co., Ltd.

About the carbon-black-containing slurry, the particle size distribution thereof is not limited as far as the proportion of the carbon black particles having a particle diameter of 60 μm or more in the carbon black particles in the slurry-solution is 35% or less by volume, this proportion being based on the measurement with the image-analytical particle size distribution meter. For example, when the producibility of the carbon-black-containing slurry is considered, the 90%-by-volume particle diameter (D90) thereof is from 30 to 120 μm both inclusive, the diameter being based on the measurement with the image-analytical particle size distribution meter. From the viewpoint of the producibility of the carbon-black-containing slurry, the 90%-by-volume particle diameter (D90) is preferably 40 μm or more, more preferably 50 μm or more. This diameter is preferably 100 μm or less, more preferably 80 μm or less to improve the carbon black in dispersibility in the rubber wet masterbatch to improve the crosslinked rubber in abrasion resistance, tear resistance and fatigue resistance. The 90%-by-volume particle diameter (D90) of particles denotes the particle diameter thereof when the cumulative volume of partial ones of the particles becomes 90% of the volume of all the particles. The same criterion is applicable to D70, D50, and D10 described below.

About the carbon-black-containing slurry, the particle size distribution thereof is not limited as far as the proportion of the carbon black particles having a particle diameter of 60 μm or more in the carbon black particles in the slurry-solution is 35% or less by volume, this proportion being based on the measurement with the image-analytical particle size distribution meter. For example, when the producibility of the carbon-black-containing slurry is considered, the 70%-by-volume particle diameter (D70) of the carbon black particles is preferably from 5 to 100 μm both inclusive, the diameter being based on the measurement with the image-analytical particle size distribution meter. From the viewpoint of the producibility of the carbon-black-containing slurry, the 70%-by-volume particle diameter (D70) is preferably 8 μm or more, more preferably 10 μm or more. This particle diameter is preferably 40 μm or less, more preferably 20 μm or less to improve the carbon black in dispersibility in the rubber wet masterbatch to improve the crosslinked rubber in abrasion resistance, tear resistance, and fatigue resistance.

About the carbon-black-containing slurry, the particle size distribution thereof is not limited as far as the proportion of the carbon black particles having a particle diameter of 60 μm or more in the carbon black particles in the slurry-solution is 35% or less by volume, this proportion being based on the measurement with the image-analytical particle size distribution meter. For example, when the producibility of the carbon-black-containing slurry is considered, the 50%-by-volume particle diameter (D50) is preferably from 3 to 60 μm both inclusive, the diameter being based on the measurement with the image-analytical particle size distribution meter. From the viewpoint of the producibility of the carbon-black-containing slurry, the 50%-by-volume particle diameter (D50) is preferably 5 μm or more, more preferably 8 μm or more. This particle diameter is preferably 20 μm or less, more preferably 10 μm or less to improve the carbon black in dispersibility in the rubber wet masterbatch to improve the crosslinked rubber in abrasion resistance, tear resistance, and fatigue resistance.

About the carbon-black-containing slurry, the particle size distribution is not limited as far as the proportion of the carbon black particles having a particle diameter of 60 μm or more in the particles of the carbon black in the slurry-solution is 35% or less by volume, this proportion being based on the measurement with the image-analytical particle size distribution meter. For example, when the producibility of the carbon-black-containing slurry is considered, the 10%-by-volume particle diameter (D10) is preferably from 1 to 20 μm both inclusive, the diameter being based on the measurement with the image-analytical particle size distribution meter. From the viewpoint of the producibility of the carbon-black-containing slurry, the 10%-by-volume particle diameter (D10) is preferably 2 μm or more, more preferably 3 μm or more. This particle diameter is preferably 10 μm or less, more preferably 5 μm or less to improve the carbon black in dispersibility in the rubber wet masterbatch to improve the crosslinked rubber in abrasion resistance, tear resistance, and fatigue resistance.

In order to remove accidental errors based on respective directions of the carbon black particles through two-dimensional image data thereon, in the measurement with the image-analytical particle size distribution meter, the average value of 15,000 or more particles selected at will is calculated.

The carbon-black-containing aqueous-slurry-solution is usually yielded by a carbon black and water as raw materials with each other.

The carbon black is any carbon black species used in an ordinary rubbery industry, such as SAF, ISAF, HAF, FEF, or GFP. The carbon black may also be an electroconductive carbon black such as acetylene black or Kitchen black. The carbon black may be any granulated carbon black, which has been granulated, considering the handleability of the carbon black in an ordinary rubbery industry; or a non-granulated carbon black. Such carbon blacks may be used singly or in any combination of two or more thereof.

About the carbon black, the nitrogen adsorption specific surface area thereof is preferably from about 30 to 250 m²/g both inclusive, more preferably from about 50 to 200 m²/g both inclusive. About the carbon black, from the viewpoint of an improvement of the resultant vulcanized rubber in abrasion resistance, the nitrogen adsorption specific area is preferably 50 m²/g or more, more preferably 60 m²/g or more, even more preferably 70 m²/g or more, and is preferably 200 m²/g or less, more preferably 180 m²/g or less, even more preferably 150 m²/g or less. About the carbon black, from the viewpoint of an improvement of the vulcanized rubber in tear resistance and fatigue resistance, the nitrogen adsorption specific area is preferably 15 m²/g or more, more preferably 20 m²/g or more, even more preferably 25 m²/g or more, and is preferably 120 m²/g or less, more preferably 80 m²/g or less, even more preferably 60 m²/g or less.

The above-mentioned medium water is a medium made of a water species, as a main component, examples of the species including ion exchange water, distilled water and industrial water. The medium may be, for example, water containing an organic solvent.

The method for mixing the carbon black with the medium water may be a method of dispersing the carbon black thereinto, using an ordinary dispersing machine such as a highly shearing mixer, a High Shear Mixer, a homo-mixer, a ball mill, a bead mill, a high-pressure homogenizer, an ultrasonic homogenizer or a colloid mill. At the time of the mixing, the whole of the mixing system, for example, the dispersing machine may be optionally heated. In this case, the temperature of the system is preferably from 20 to 80° C., more preferably from 30 to 70° C.

The “highly shearing mixer” means a mixer having a high-speed-rotatable rotor and a fixed stator in which in the state of setting a precise clearance between the rotor and the stator, the rotor is rotated so that a highly shearing effect acts. Such a highly shearing mixer may be a commercially available product. Examples thereof include products “High Shear Mixer” manufactured by Silverson Machines, Inc., “High Shear Mixer IKA 2000 series” manufactured by IKA the company IKA, “T.K. Homo-mixer” manufactured by Tokushu Kika Kogyo Co., Ltd., “Ultra Homo-mixer” manufactured by Mizuho Industrial Co., Ltd., “Clearmix” manufactured by M Technique Co., Ltd., and “Cavitron” manufactured by Pacific Machinery & Engineering Co., Ltd. In the highly shearing mixer, its work head (stator) may be, for example, a round-hole head, a rectangular-hole head, or slot (slit) head. The slot head is preferred to make the carbon black into small particle diameters effectively.

The proportion of the carbon black in the carbon-black-containing aqueous-slurry-solution is preferably from 1 to 20% by weight. The proportion of the carbon black in the carbon-black-containing aqueous-slurry-solution is more preferably 2% or more, even more preferably 5% or more by weight to heighten the efficiency of removing the medium water in the dehydrating/drying step. The proportion of the carbon black in the carbon-black-containing slurry solution is more preferably 15% or less, even more preferably 12% or less by weight to lower the carbon-black-containing aqueous-slurry-solution in viscosity to heighten the efficiency of stirring the aqueous-slurry-solution.

### <Rubber Latex Solution>

As the rubber latex solution, a natural rubber latex solution and a synthetic rubber latex solution are usable.

The natural rubber latex solution is a natural product based on a metabolic effect of plants, and is preferably a natural-rubber/water based latex solution in which a dispersing solvent is, particularly, water. The number-average molecular weight of the natural rubber in the natural rubber latex is preferably 2000000 or more, more preferably 2500000 or more. About the natural rubber latex solution, concentrated latex, fresh latex called field latex, and other latexes can be used without being distinguished from each other. The synthetic rubber latex solution is, for example, a latex solution in which a rubber is produced by emulsion polymerization, examples of this rubber including styrene-butadiene rubber, butadiene rubber, nitrile rubber, and chloroprene rubber. Such rubber latex solutions may be used singly or in any combination of two or more thereof.

The step (I) includes an operation of mixing the above-mentioned carbon-black-containing aqueous-slurry-solution with the above-mentioned rubber latex solution to produce a carbon-black-containing aqueous-rubber-latex-solution. The method for mixing the carbon-black-containing aqueous-slurry-solution with the rubber latex solution in a liquid phase is not particularly limited, and is, for example, a method of attaining the mixing, using an ordinary dispersing machine or a mixing machine in which a blade is rotated in a cylindrical vessel, examples of the machine including a highly shearing mixer, a High Shear Mixer, a homo-mixer, a ball mill, a bead mill, a high-pressure homogenizer, an ultrasonic homogenizer and a colloid mill. At the time of the mixing, the whole of the mixing system, for example, the dispersing machine may be optionally heated.

In the present invention, the step (I) may include a step (I-1) of adding, at the time of dispersing the carbon black into the medium water, at least one portion of the rubber latex solution into the present dispersing system to produce a carbon-black-containing aqueous-slurry-solution in which rubber latex particles adhere to the carbon black; and a step (I-2) of mixing the resultant carbon-black-containing aqueous-slurry-solution, in which the rubber latex particles adhere to the carbon black, with the rest of the rubber latex solution to produce a carbon-black-containing aqueous-rubber-latex-solution in which the rubber latex particles adhere onto the carbon black.

The amount of the carbon black is preferably from 10 to 120 parts by weight for 100 parts by weight of the rubber component(s) in the rubber wet masterbatch. About the carbon black, from the viewpoint of an improvement thereof in vulcanized-rubber-reinforcing performance, the amount is 20 parts or more, more preferably 30 parts or more by weight for 100 parts by weight of the rubber component(s) in the rubber wet masterbatch, and is preferably 100 parts or less, more preferably 80 parts or less therefor. From the viewpoint of an improvement of the vulcanized rubber in tear resistance and fatigue resistance, the amount of the carbon black is preferably 10 parts or more, more preferably 25 parts or more by weight for 100 parts by weight of the rubber component(s) in the rubber wet masterbatch, and is preferably 60 parts or less, more preferably 50 parts by weight, even more preferably 40 parts by weight therefor.

### <Step (II)>

The step (II) in the present invention includes an operation of solidifying the carbon-black-containing aqueous-rubber-latex-solution yielded through the above-mentioned step to produce a carbon-black-containing rubber solidified product.

The method for the solidifying may be a method of incorporating a solidifier into the carbon-black-containing aqueous-rubber-latex-solution. Usable examples of the solidifier include acids such as formic acid and sulfuric acid, and salts such as sodium chloride, these acids or salts being ones usually used to solidify a rubber latex solution.

### <Step (III)>

The step (III) in the present invention includes an operation of dehydrating and drying the carbon-black-containing rubber solidified product to produce a rubber wet masterbatch. The method for the dehydrating/drying may be a method using a dehydrating/drying machine that may be of various types, such as a uniaxial extruder, a biaxial extruder, an oven, a conveyer-type drier, a vacuum drier, or an air drier. The present rubber-wet-masterbatch-producing method may include, before the step (III), a centrifugal separation step, or a solid/liquid-separating step using a vibrating screen in order to decrease appropriately the water amount contained in the carbon-black-containing rubber solidified product. Alternatively, the method may include a washing step, such as a water washing method, to wash the solidified product.

### <Step (IV)>

The rubber-composition-producing method of the present invention includes a step (IV) of using the rubber wet masterbatch yielded through the above-mentioned steps to attain the drying and mixing.

In the step (IV), various blending agents are further usable. The usable blending agents may be blending agents used ordinarily in the rubber industry. Examples thereof include rubbers, sulfur-based vulcanizers, vulcanization promoters, antiaging agents, silica, silane coupling agents, zinc oxide, methylene acceptors and methylene donors, stearic acid, vulcanization promotion aids, vulcanization retarders, organic peroxides, softeners such as wax and oil, and working aids.

The rubbers are each a component used separately from the rubber component(s) originating from the rubber wet masterbatch. Examples of the rubbers include natural rubber (NR); and synthetic diene rubbers such as isoprene rubber (IR), styrene-butadiene rubber (SBR), butadiene rubber (BR), chloroprene rubber (CR), and nitrile rubber (NBR). Such rubbers may be used singly or in any combination of two or more thereof.

The content of the carbon black is preferably from 10 to 120 parts by weight for 100 parts by weight of the rubber component(s) in the rubber composition. From the viewpoint of an improvement of the vulcanized rubber in reinforceability, the amount of the carbon black is preferably 20 parts or more, more preferably 30 parts or more by weight for 100 parts by weight of the rubber component(s) in the rubber composition, and is preferably 100 parts or less, more preferably 80 parts or less, even more preferably 70 parts or less by weight therefor. From the viewpoint of an improvement of the vulcanized rubber in tear resistance and fatigue resistance, the amount of the carbon black is preferably 10 parts or more, more preferably 25 parts or more by weight for 100 parts by weight of the rubber component(s) in the rubber composition, and is preferably 60 parts or less, more preferably 50 parts or less, even more preferably 40 parts or less by weight therefor.

The species of sulfur for the sulfur-based vulcanizers may be any ordinary sulfur species for rubbers. Examples of the species include powdery sulfur, precipitated sulfur, insoluble sulfur, and highly dispersed sulfur. The sulfur-based vulcanizers may be used singly or in any combination of two or more thereof.

The content of the sulfur species is preferably from 0.3 to 6.5 parts by weight for 100 parts by weight of the rubber component(s) in the rubber composition. If the content of the sulfur species is less than 0.3 parts by weight, the vulcanized rubber is short in crosslinkage density to be lowered in rubber strength and others. If the content is more than 6.5 parts by weight, the vulcanized rubber is deteriorated, in particular, in both of heat resistance and endurance. The content of the sulfur species is more preferably from 1.0 to 5.5 parts by weight for 100 parts by weight of the rubber component(s) in the rubber composition to cause the vulcanized rubber to keep a good rubber strength and have further improved heat resistance and endurance.

The vulcanization promoters may each be any ordinary vulcanization promoter for rubbers. Examples thereof include sulfenamide based, thiuram based, thiazole based, thiourea based, guanidine based and dithiocarbamic acid salt based vulcanization promoters. The vulcanization promoters may be used singly or in any combination of two or more thereof.

The content of the vulcanization promoter(s) is preferably from 1 to 5 parts by weight for 100 parts by weight of the rubber component(s) in the rubber composition.

The antiaging agents may each be any ordinary antiaging agent for rubbers. Examples thereof include aromatic amine based, amine-ketone based, monophenol based, bisphenol based, polyphenol based, dithiocarbamic acid salt based, and thiourea based antiaging agents. The antiaging agents may be used singly or in any combination of two or more thereof.

The content of the antiaging agent(s) is preferably from 1 to 5 parts by weight for 100 parts by weight of the rubber component(s) in the rubber composition.

In the step (IV), the method for blending (or adding) the rubber wet masterbatch, and the various blending agents into each other is, for example, a method of kneading these components using a kneading machine used in an ordinary rubber industry, such as a Banbury mixer, a kneader, or a roll.

The kneading method is not particularly limited, and is, for example, a method of adding components other than vulcanization-related components, such any sulfur based vulcanizer and any vulcanization promoter, to each other in any order or adding these components to each other simultaneously, so as to knead these components, or a method of adding all the components to each other simultaneously to knead the components. The number of times of the kneading may be one or plural. The period for the kneading is varied in accordance with the size of a kneading machine used for the kneading, and some other factor. It is advisable to set the period usually into the range of about 2 to 5 minutes. The discharging-temperature of the rubber composition in the kneading machine is set to a range preferably from 120 to 170° C., more preferably from 120 to 150° C. When the rubber composition includes one or more of the vulcanization related components, the discharging-temperature in the kneading machine is set to a range preferably from 80 to 110° C., more preferably from 80 to 100° C.

The rubber-wet-masterbatch-producing method of the present invention or the rubber-composition-producing method thereof makes it possible to yield a vulcanized rubber excellent in abrasion resistance or a vulcanized rubber excellent in tear resistance and fatigue resistance while the rubber is low in exothermicity. Moreover, a rubber wet masterbatch and a rubber composition yielded in the present invention are suitable for pneumatic tires (for example, their tire tread moieties, and ply topping moieties).

### EXAMPLES

Hereinafter, the present invention will be described by way of working examples thereof. However, the invention is never limited by these working examples.

Hereinafter, embodiments related to the first object will be described.

### <Preparation of Carbon-Black-Containing Aqueous-Slurry-Solutions>

### Preparation Example 1

To water was added a carbon black (SEAST 3 (HAF), manufactured by Tokai Carbon Co., Ltd.; nitrogen adsorption specific surface area: 79 m²/g), and then a “High Shear Mixer” manufactured by Silverson Machines, Inc. was used to disperse the carbon black in water (High Shear Mixer conditions: its work head (stator) was a slot type head (slot interval: 3 mm); the rotation number thereof was 3,600 rpm; the treating period was 10 minutes; and the treating temperature was 50° C.) to prepare a carbon-black-containing aqueous-slurry-solution 1 having a carbon black concentration of 5% by weight.

### Preparation Example 2

A carbon-black-containing aqueous-slurry-solution 2 was prepared by the same operations as in Preparation Example 1 except that in the Preparation Example 1 the treating period was changed to 15 minutes.

### Preparation Example 3

A carbon-black-containing aqueous-slurry-solution 3 was prepared by the same operations as in Preparation Example 1 except that in Preparation Example 1 the treating period was changed to 30 minutes.

### Preparation Example 4

To water was added a carbon black (“DIABLACK A (SAF)”, manufactured by Mitsubishi Chemical Corp.; nitrogen adsorption specific surface area: 142 m²/g), and then a “High Shear Mixer” manufactured by Silverson Machines, Inc. was used to disperse the carbon black in water (High Shear Mixer conditions: its work head (stator) was a slot type head (slot interval: 3 mm); the rotation number thereof was 3,600 rpm; the treating period was 10 minutes; and the treating temperature was 50° C.) to prepare a carbon-black-containing aqueous-slurry-solution 4 having a carbon black concentration of 10% by weight.

### Preparation Example 5

A carbon-black-containing aqueous-slurry-solution 5 was prepared by the same operations as in Preparation Example 4 except that in Preparation Example 4 the treating period was changed to 15 minutes.

### Preparation Example 6

A carbon-black-containing aqueous-slurry-solution 6 was prepared by the same operations as in Preparation Example 4 except that in Preparation Example 4 the treating period was changed to 30 minutes.

### Comparative Preparation Example A

A carbon-black-containing aqueous-slurry-solution A was prepared by the same operations as in Preparation Example 1 except that in Preparation Example 1, the work head (stator) was changed from the slot type head (slot interval: 3 mm) to a round work head (circle diameter: 10 mm), and the treating period was changed to 30 minutes.

### Comparative Preparation Example B

A carbon-black-containing aqueous-slurry-solution B was prepared by the same operations as in Preparation Example 4 except that in Preparation Example 4, the work head (stator) was changed from the slot type head (slot interval: 3 mm) to a round work head (circle diameter: 10 mm), and the treating period was changed to 30 minutes.

### <Evaluation of Carbon Black Particles Contained in Each of Carbon-Black-Containing Aqueous-Slurry-Solutions>

Water was added to the carbon-black-containing aqueous-slurry-solution yielded in each of Preparation Examples 1 to 6 and Comparative Preparation Examples A and B to dilute the solution to prepare a carbon black dispersion having a concentration of 0.005% by weight. Next, the following were gained, using an image-analytic particle size distribution meter (“IF-3200”, manufactured by JASCO International Co., Ltd.; analyzing software: “PIA-Pro Image Analyzing Software ver. 2016 under measuring conditions that the cell thickness was 50 μm, the sample concentration was 0.005% by weight, and the number of cumulative particles to be analyzed was from 15,000 to 30,000): the proportion of carbon black particles having a particle diameter of 60 μm or more therein; and the D90, D70, D50, and D10 of the carbon black particles. The results are shown in Table 1.

TABLE 1

| | Carbon-black-containing aqueous-slurry-solutions | | | | | | | |
|---|---|---|---|---|---|---|---|---|
| | 1 | 2 | 3 | 4 | 5 | 6 | A | B |
| Carbon black | SEAST 3 | SEAST 3 | SEAST 3 | DIABLACK A | DIABLACK A | DIABLACK A | SEAST 3 | DIABLACK A |
| Proportion (% by | 30 | 22 | 11 | 30 | 21 | 9 | 43 | 39 |
| volume) of carbon | | | | | | | | |
| black particles | | | | | | | | |
| having particle | | | | | | | | |
| diameter of 60 μm | | | | | | | | |
| or more | | | | | | | | |
| 10%-by-volume | 7 | 6 | 4 | 8 | 7 | 5 | 9 | 10 |
| particle diameter | | | | | | | | |
| (μm) | | | | | | | | |
| 50%-by-volume | 30 | 29 | 10 | 33 | 17 | 9 | 55 | 60 |
| particle diameter | | | | | | | | |
| (μm) | | | | | | | | |
| 70%-by-volume | 60 | 33 | 13 | 60 | 30 | 12 | 80 | 100 |
| particle diameter | | | | | | | | |
| (μm) | | | | | | | | |
| 90%-by-volume | 110 | 105 | 60 | 105 | 100 | 60 | 115 | 120 |
| particle diameter | | | | | | | | |
| (μm) | | | | | | | | |

(Used Materials Other than Carbon Black)

a) Natural rubber latex solution: “NR field latex” (manufactured by a company Golden Hope) (DRC=31.2%);
b) Zinc oxide: “Zinc Oxide, species 2” (manufactured by Mitsui Mining & Smelting Co., Ltd.;
c) Stearic acid: “RUNACK S-20” (manufactured by Kao Corp.);
d) Wax: “OZOACE 0355” (manufactured by Nippon Seiro Co., Ltd.);
e) Antiaging agent (A): “NOCRAC 6C” (manufactured by Ouchi Shinko Chemical Industrial Co., Ltd.;
f) Antiaging agent (B): Polymerized-2,2,4-trimethyl-1,2-dihydroquinoline (ANTAGE RD, manufactured by Kawaguchi Chemical Industry Co., LTD.);
j) Sulfur: “5%-OIL-INCORPORATED FINELY-POWDERY SULFUR” (manufactured by Tsurumi Chemical Industry Co., Ltd.); and
h) Vulcanization promoter: N-tert-butyl-2-benzothiazolylsulfenamide: “NOCCELLAR NS-P” (manufactured by Ouchi Shinko Chemical Industrial Co., Ltd.).

### Example 1

### <Step (I): Production of Carbon-Black-Containing Aqueous-Rubber-Latex-Solution>

A natural rubber latex solution (25% by weight) was added, at ambient temperature, into the carbon-black-containing aqueous-slurry-solution 1 yielded through the above-mentioned step to give a solid content (rubber component) of 100 parts by weight for 50 parts by weight of the carbon black. Next, a mixer (Super Mixer SMV-20) manufactured by Kawata Mfg. Co., Ltd. was used to mix the existing components with each other to prepare a carbon-black-containing aqueous-rubber-latex-solution.

### <Step (II): Production of Carbon-Black-Containing Rubber Solidified Product>

Subsequently, while the mixer (Super Mixer SMV-20) manufactured by Kawata Mfg. Co., Ltd. was used to blend formic acid (10% solution) as a solidifier into the carbon-black-containing aqueous-rubber-latex-solution (90° C.) produced in the step (I), the solidifier was added to the solution until the pH of the whole of the solution turned into 4. In this way, a carbon-black-containing rubber solidified product was produced (step (II)).

### <Step (III): Production of Rubber Wet Masterbatch>

A squeezer type uniaxial extruding/dehydrating machine (V-02 type, manufactured by Suehiro EPM Corp.) was used to dehydrate and dry the carbon-black-containing rubber solidified product produced in the step (II) until the water content therein turned to 1.5% or less. In this way, a rubber wet masterbatch was produced (step (III)).

### <Step (IV): Production of Rubber Composition and Unvulcanized Rubber Composition>

A Banbury mixer was used to dry-mix the rubber wet masterbatch yielded through the above-mentioned steps with individual materials (other than any sulfur and any vulcanization promoter) shown in Table 2 (kneading period: 3 minutes; composition-discharging-temperature: 150° C.). In this way, a rubber composition was produced. Next, to the resultant rubber composition were added sulfur and a vulcanization promoter shown in Table 2, and then the Banbury mixer was used to dry-mix all the components (kneading period: 1 minute; composition-discharging-temperature: 90° C.). In this way, an unvulcanized rubber composition was produced. The blend proportion of any component in Table 2 is represented by the numerical value (phr) of the part(s) by weight of this component when the whole amount of the rubber component contained in the corresponding rubber composition is regarded as 100 parts by weight.

### Examples 2 to 6, and Comparative Examples 1 and 2

A rubber wet masterbatch, a rubber composition and an unvulcanized rubber composition of each of Examples 2 to 6 and Comparative Examples 1 and 2 were produced in the same way as in Example 1 except that in the item <Step (I): Production of Carbon-Black-Containing Aqueous-Rubber-Latex-Solution> in Example 1, the used carbon-black-containing aqueous-slurry-solution was changed to one shown in Table 1, and in the item <Step (IV): Production of Rubber Composition and Unvulcanized Rubber Composition>, the respective blend amounts of the used materials were changed as shown in Table 2.

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 2.

### <Exothermicity Evaluation>

About the evaluation of the exothermicity of each of the examples, in accordance with JIS K6394, a viscoelasticity tester (“Rheospectrometer E4000” manufactured by a company UBM in Japan) was used to measure the loss coefficient tan δ under conditions of a static strain of 10%, a dynamic strain of 2%, a frequency of 50 Hz, and a temperature of 80° C. The value in each of Examples 1 to 3 was represented by an index relative to the value regarded as 100 in Comparative Example 1; and that in each of Examples 4 to 6, by an index relative to the value regarded as 100 in Comparative Example 2. It is demonstrated that as the examples are smaller in index, the examples less easily generate heat to be better in low exothermicity to be better in low fuel consumption performance for tires.

### <Abrasion Resistances Evaluation>

About the evaluation of the abrasion resistance, in accordance with JIS K6264, a Lambourn abrasion tester manufactured by Iwamoto Seisakusho Co., Ltd. was used to measure the abrasion loss of a test piece of the resultant vulcanized rubber in each of the examples at a load of 40 N, a slip percentage of 30%, a temperature of 23° C., and a dropped sand amount of 20 g/minute. The inverse number of the abrasion loss in each of Examples 1 to 3 was represented by an index relative to the value regarded as 100 in Comparative Example 1; and that in each of Examples 4 to 6, by an index relative to the value regarded as 100 in Comparative Example 2. It is demonstrated that the examples are larger in index, the examples are smaller in abrasion loss to be better in abrasion resistance.

TABLE 2

| | | Comparative | Ex- | Ex- | | Comparative | | | |
|---|---|---|---|---|---|---|---|---|---|
| | | Example 1 | ample 1 | ample 2 | Example 3 | Example 2 | Example 4 | Example 5 | Example 6 |
| Steps (I) | Natural rubber latex | 100 | 100 | 100 | 100 | 100 | 100 | 100 | 100 |
| to (III) | (solid content therein) | | | | | | | | |
| | Carbon-black-containing | | 50 | | | | | | |
| | aqueous-slurry-solution 1 | | | | | | | | |
| | (solid content therein) | | | | | | | | |
| | Carbon-black-containing | | | 50 | | | | | |
| | aqueous-slurry-solution 2 | | | | | | | | |
| | (solid content therein) | | | | | | | | |
| | Carbon-black-containing | | | | 50 | | | | |
| | aqueous-slurry-solution 3 | | | | | | | | |
| | (solid content therein) | | | | | | | | |
| | Carbon-black-containing | | | | | | 50 | | |
| | aqueous-slurry-solution 4 | | | | | | | | |
| | (solid content therein) | | | | | | | | |
| | Carbon-black-containing | | | | | | | 50 | |
| | aqueous-slurry-solution 5 | | | | | | | | |
| | (solid content therein) | | | | | | | | |
| | Carbon-black-containing | | | | | | | | 50 |
| | aqueous-slurry-solution 6 | | | | | | | | |
| | (solid content therein) | | | | | | | | |
| | Carbon-black-containing | 50 | | | | | | | |
| | aqueous-slurry-solution A | | | | | | | | |
| | (solid content therein) | | | | | | | | |
| | Carbon-black-containing | | | | | 50 | | | |
| | aqueous-slurry-solution B | | | | | | | | |
| | (solid content therein) | | | | | | | | |
| Step (IV) | zinc oxide | 1 | 1 | 1 | 1 | 1 | 1 | 1 | 1 |
| | Stearic acid | 2 | 2 | 2 | 2 | 2 | 2 | 2 | 2 |
| | Wax | 1 | 1 | 1 | 1 | 1 | 1 | 1 | 1 |
| | Antiaging agent (A) | 2 | 2 | 2 | 2 | 2 | 2 | 2 | 2 |
| | Antiaging agent (B) | 1 | 1 | 1 | 1 | 1 | 1 | 1 | 1 |
| | Sulfur | 2 | 2 | 2 | 2 | 2 | 2 | 2 | 2 |
| | Vulcanization promoter | 1 | 1 | 1 | 1 | 1 | 1 | 1 | 1 |
| Evaluations | Exothermicity | 100 | 98 | 100 | 99 | 100 | 99 | 100 | 98 |
| | Abrasion resistance | 100 | 115 | 122 | 131 | 100 | 113 | 123 | 130 |

Hereinafter, embodiments related to the second object will be described.

### <Preparation of Carbon-Black-Containing Aqueous-Slurry-Solutions>

### Preparation Example 1

To water was added a carbon black (SEAST 3 (HAF), manufactured by Tokai Carbon Co., Ltd.; nitrogen adsorption specific surface area: 79 m²/g), and then a “High Shear Mixer” manufactured by Silverson Machines, Inc. was used to disperse the carbon black in water (High Shear Mixer conditions: its work head (stator) was a slot type head (slot interval: 3 mm); the rotation number thereof was 3,600 rpm; the treating period was 30 minutes; and the treating temperature was 50° C.) to prepare a carbon-black-containing aqueous-slurry-solution 1 having a carbon black concentration of 10% by weight.

### Preparation Example 2

A carbon-black-containing aqueous-slurry-solution 2 was prepared by the same operations as in Preparation Example 1 except that in Preparation Example 1 the species of the carbon black was changed to a carbon black (“DIABLACK A (SAF) manufactured by Mitsubishi Chemical Corp.; nitrogen adsorption specific surface area: 142 m²/g).

### Preparation Example 3

A carbon-black-containing aqueous-slurry-solution 3 was prepared by the same operations as in Preparation Example 1 except that in Preparation Example 1 the species of the carbon black was changed to a carbon black (“SEAST 6 (ISAF) manufactured by Tokai Carbon Co., Ltd.; nitrogen adsorption specific surface area: 119 m²/g).

### Preparation Example 4

A carbon-black-containing aqueous-slurry-solution 4 was prepared by the same operations as in Preparation Example 1 except that in Preparation Example 1 the species of the carbon black was changed to a carbon black (“SEAST SO (FEF) manufactured by Tokai Carbon Co., Ltd.; nitrogen adsorption specific surface area: 42 m²/g).

### Preparation Example 5

A carbon-black-containing aqueous-slurry-solution 5 was prepared by the same operations as in Preparation Example 1 except that in Preparation Example 1 the treating period was changed to 10 minutes.

### Comparative Preparation Example A

A carbon-black-containing aqueous-slurry-solution A was prepared by the same operations as in Preparation Example 1 except that in Preparation Example 1, the work head (stator) was changed from the slot type head (slot interval: 3 mm) to a round work head (circle diameter: 10 mm).

### Comparative Preparation Example B

A carbon-black-containing aqueous-slurry-solution B was prepared by the same operations as in Preparation Example 2 except that in Preparation Example 2, the work head (stator) was changed from the slot type head (slot interval: 3 mm) to a round work head (circle diameter: 10 mm).

### Comparative Preparation Example C

A carbon-black-containing aqueous-slurry-solution C was prepared by the same operations as in Preparation Example 3 except that in Preparation Example 3, the work head (stator) was changed from the slot type head (slot interval: 3 mm) to a round work head (circle diameter: 10 mm).

### Comparative Preparation Example D

A carbon-black-containing aqueous-slurry-solution D was prepared by the same operations as in Preparation Example 4 except that in Preparation Example 4, the work head (stator) was changed from the slot type head (slot interval: 3 mm) to a round work head (circle diameter: 10 mm).

### <Evaluation of Carbon Black Particles Contained in Each of Carbon-Black-Containing Aqueous-Slurry-Solutions>

Water was added to the carbon-black-containing aqueous-slurry-solution yielded in each of Preparation Examples 1 to 5 and Comparative Preparation Examples A to D to dilute the solution to prepare a carbon black dispersion having a concentration of 0.005% by weight. Next, the following were gained, using an image-analytic particle size distribution meter (“IF-3200”, manufactured by JASCO International Co., Ltd.; analyzing software: “PIA-Pro Image Analyzing Software ver. 2016 under measuring conditions that the cell thickness was 50 μm, the sample concentration was 0.005% by weight, and the number of cumulative particles to be analyzed was from 15,000 to 30,000): the proportion of carbon black particles having a particle diameter of 60 μm or more therein; and the D90, D70, D50, and D10 of the carbon black particles. The results are shown in Table 3.

TABLE 3

| | Carbon-black-containing aqueous-slurry-solutions | | | | | | | | |
|---|---|---|---|---|---|---|---|---|---|
| | 1 | 2 | 3 | 4 | 5 | A | B | C | D |
| Carbon black | SEAST 3 | DIABLACK A | SEAST 6 | SEAST | SEAST 3 | SEAST 3 | DIABLACK A | SEAST 6 | SEAST |
| | | | | SO | | | | | SO |
| Proportion (% by | 11 | 9 | 10 | 10 | 30 | 43 | 39 | 40 | 40 |
| volume) of | | | | | | | | | |
| carbon black | | | | | | | | | |
| particles | | | | | | | | | |
| having particle | | | | | | | | | |
| diameter of 60 μm | | | | | | | | | |
| or more | | | | | | | | | |
| 10%-by-volume | 4 | 5 | 5 | 5 | 7 | 9 | 10 | 9 | 9 |
| particle | | | | | | | | | |
| diameter | | | | | | | | | |
| (μm) | | | | | | | | | |
| 50%-by-volume | 10 | 9 | 10 | 12 | 30 | 55 | 60 | 53 | 54 |
| particle | | | | | | | | | |
| diameter | | | | | | | | | |
| (μm) | | | | | | | | | |
| 70%-by-volume | 13 | 12 | 13 | 15 | 60 | 80 | 100 | 79 | 80 |
| particle | | | | | | | | | |
| diameter | | | | | | | | | |
| (μm) | | | | | | | | | |
| 90%-by-volume | 60 | 60 | 60 | 60 | 110 | 115 | 120 | 116 | 115 |
| particle | | | | | | | | | |
| diameter | | | | | | | | | |
| (μm) | | | | | | | | | |

(Used Materials Other than Carbon Black)

a) Natural rubber latex solution: “NR field latex” (manufactured by a company Golden Hope) (DRC=31.2%);
b) Zinc oxide: “Zinc Oxide, species 2” (manufactured by Mitsui Mining & Smelting Co., Ltd.;
c) Stearic acid: “RUNACK S-20” (manufactured by Kao Corp.);
d) Wax: “OZOACE 0355” (manufactured by Nippon Seiro Co., Ltd.);
e) Antiaging agent (A): “NOCRAC 6C” (manufactured by Ouchi Shinko Chemical Industrial Co., Ltd.;
f) Antiaging agent (B): Polymerized-2,2,4-trimethyl-1,2-dihydroquinoline (ANTAGE RD, manufactured by Kawaguchi Chemical Industry Co., LTD.);
j) Sulfur: “5%-OIL-INCORPORATED FINELY-POWDERY SULFUR” (manufactured by Tsurumi Chemical Industry Co., Ltd.); and
h) Vulcanization promoter: N-tert-butyl-2-benzothiazolylsulfenamide: “NOCCELLAR NS-P” (manufactured by Ouchi Shinko Chemical Industrial Co., Ltd.).

### Example 1

### <Step (I): Production of Carbon-Black-Containing Aqueous-Rubber-Latex-Solution>

A natural rubber latex solution (25% by weight) was added, at ambient temperature, into the carbon-black-containing aqueous-slurry-solution 1 yielded through the above-mentioned step to give a solid content (rubber component) of 100 parts by weight for 40 parts by weight of the carbon black. Next, a mixer (Super Mixer SMV-20) manufactured by Kawata Mfg. Co., Ltd. was used to mix the existing components with each other to prepare a carbon-black-containing aqueous-rubber-latex-solution.

### <Step (II): Production of Carbon-Black-Containing Rubber Solidified Product>

Subsequently, while the mixer (Super Mixer SMV-20) manufactured by Kawata Mfg. Co., Ltd. was used to blend formic acid (10% solution) as a solidifier into the carbon-black-containing aqueous-rubber-latex-solution (90° C.) produced in the step (I), the solidifier was added to the solution until the pH of the whole of the solution turned into 4. In this way, a carbon-black-containing rubber solidified product was produced (step (II)).

### <Step (III): Production of Rubber Wet Masterbatch>

A squeezer type uniaxial extruding/dehydrating machine (V-02 type, manufactured by Suehiro EPM Corp.) was used to dehydrate and dry the carbon-black-containing rubber solidified product produced in the step (II) until the water content therein turned to 1.5% or less. In this way, a rubber wet masterbatch was produced (step (III)).

### <Step (IV): Production of Rubber Composition and Unvulcanized Rubber Composition>

A Banbury mixer was used to dry-mix the rubber wet masterbatch yielded through the above-mentioned steps with individual materials (other than any sulfur and any vulcanization promoter) shown in Table 4 (kneading period: 3 minutes; composition-discharging-temperature: 150° C.). In this way, a rubber composition was produced. Next, to the resultant rubber composition were added sulfur and a vulcanization promoter shown in Table 2, and then the Banbury mixer was used to dry-mix all the components (kneading period: 1 minute; composition-discharging-temperature: 90° C.). In this way, an unvulcanized rubber composition was produced. The blend proportion of any component in Table 4 is represented by the numerical value (phr) of the part(s) by weight of this component when the whole amount of the rubber component contained in the corresponding rubber composition is regarded as 100 parts by weight.

### Examples 2 to 9, and Comparative Examples 1 to 8

A rubber wet masterbatch, a rubber composition and an unvulcanized rubber composition of each of Examples 2 to 9 and Comparative Examples 1 to 8 were produced in the same way as in Example 1 except that in the item <Step (I): Production of Carbon-Black-Containing Aqueous-Rubber-Latex-Solution> in Example 1, the used carbon-black-containing aqueous-slurry-solution was changed to one shown in Table 3, and in the item <Step (IV): Production of Rubber Composition and Unvulcanized Rubber Composition>, the respective blend amounts of the used materials were changed as shown in Table 4 or 5.

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 4 or 5.

### <Exothermicity Evaluation>

About the evaluation of the exothermicity of each of the examples, in accordance with JIS K6394, a viscoelasticity tester (“Rheospectrometer E4000”, manufactured by a company UBM in Japan) was used to measure the loss coefficient tan δ under conditions of a static strain of 10%, a dynamic strain of 2%, a frequency of 50 Hz, and a temperature of 80° C. The value in each of Examples 1 and 9 was represented by an index relative to the value regarded as 100 in Comparative Example 1; that in Example 2, by an index relative to the value regarded as 100 in Comparative Example 2; that in Example 3, by an index relative to the value regarded as 100 in Comparative Example 3; that in Example 4, by an index relative to the value regarded as 100 in Comparative Example 4; that in Example 5, by an index relative to the value regarded as 100 in Comparative Example 5; that in Example 6, by an index relative to the value regarded as 100 in Comparative Example 6; that in Example 7, by an index relative to the value regarded as 100 in Comparative Example 7; and that in Example 8, by an index relative to the value regarded as 100 in Comparative Example 8. It is demonstrated that as the examples are smaller in index, the examples less easily generate heat to be better in low exothermicity to be better in low fuel consumption performance for tires.

### <Abrasion Resistances Evaluation>

About the abrasion resistance of each of the examples, in accordance with JIS K6264, a Lambourn abrasion tester manufactured by Iwamoto Seisakusho Co., Ltd. was used to measure the abrasion loss of the example at a load of 40 N, a slip percentage of 30%, a temperature of 23° C. and a dropped sand amount of 20 g/minute. The inverse number of the abrasion loss in each of Examples 1 and 9 was represented by an index relative to the value regarded as 100 in Comparative Example 1; that in Example 2, by an index relative to the value regarded as 100 in Comparative Example 2; that in Example 3, by an index relative to the value regarded as 100 in Comparative Example 3; that in Example 4, by an index relative to the value regarded as 100 in Comparative Example 4; that in Example 5, by an index relative to the value regarded as 100 in Comparative Example 5; that in Example 6, by an index relative to the value regarded as 100 in Comparative Example 6; that in Example 7, by an index relative to the value regarded as 100 in Comparative Example 7; and that in Example 8, by an index relative to the value regarded as 100 in Comparative Example 8. It is demonstrated that the examples are larger in index, the examples are smaller in abrasion loss to be better in abrasion resistance.

TABLE 4

| | | Com- | | Com- | | Com- | | | | | |
|---|---|---|---|---|---|---|---|---|---|---|---|
| | | parative | Ex- | parative | Ex- | parative | Ex- | Comparative | Ex- | Comparative | Ex- |
| | | Example 1 | ample 1 | Example 2 | ample 2 | Example 3 | ample 3 | Example 4 | ample 4 | Example 5 | ample 5 |
| Steps | Natural rubber latex | 100 | 100 | 100 | 100 | 100 | 100 | 100 | 100 | 100 | 100 |
| (I) to | (solid content therein) | | | | | | | | | | |
| (III) | Carbon-black-containing | | 40 | | 30 | | 70 | | 20 | | 80 |
| | aqueous-slurry-solution 1 | | | | | | | | | | |
| | (solid content therein) | | | | | | | | | | |
| | Carbon-black-containing | | | | | | | | | | |
| | aqueous-slurry-solution 2 | | | | | | | | | | |
| | (solid content therein) | | | | | | | | | | |
| | Carbon-black-containing | | | | | | | | | | |
| | aqueous-slurry-solution 3 | | | | | | | | | | |
| | (solid content therein) | | | | | | | | | | |
| | Carbon-black-containing | | | | | | | | | | |
| | aqueous-slurry-solution 4 | | | | | | | | | | |
| | (solid content therein) | | | | | | | | | | |
| | Carbon-black-containing | | | | | | | | | | |
| | aqueous-slurry-solution 5 | | | | | | | | | | |
| | (solid content therein) | | | | | | | | | | |
| | Carbon-black-containing | 40 | | 30 | | 70 | | 20 | | 60 | |
| | aqueous-slurry-solution A | | | | | | | | | | |
| | (solid content therein) | | | | | | | | | | |
| | Carbon-black-containing | | | | | | | | | | |
| | aqueous-slurry-solution B | | | | | | | | | | |
| | (solid content therein) | | | | | | | | | | |
| | Carbon-black-containing | | | | | | | | | | |
| | aqueous-slurry-solution C | | | | | | | | | | |
| | (solid content therein) | | | | | | | | | | |
| | Carbon-black-containing | | | | | | | | | | |
| | aqueous-slurry-solution D | | | | | | | | | | |
| | (solid content therein) | | | | | | | | | | |
| Step | zinc oxide | 1 | 1 | 1 | 1 | 1 | 1 | 1 | 1 | 1 | 1 |
| (IV) | Stearic acid | 2 | 2 | 2 | 2 | 2 | 2 | 2 | 2 | 2 | 2 |
| | Wax | 1 | 1 | 1 | 1 | 1 | 1 | 1 | 1 | 1 | 1 |
| | Antiaging agent (A) | 2 | 2 | 2 | 2 | 2 | 2 | 2 | 2 | 2 | 2 |
| | Antiaging agent (B) | 1 | 1 | 1 | 1 | 1 | 1 | 1 | 1 | 1 | 1 |
| | Sulfur | 2 | 2 | 2 | 2 | 2 | 2 | 2 | 2 | 2 | 2 |
| | Vulcanization promoter | 1 | 1 | 1 | 1 | 1 | 1 | 1 | 1 | 1 | 1 |
| Eval- | Exothermicity | 100 | 98 | 100 | 97 | 100 | 99 | 100 | 100 | 100 | 99 |
| uations | Abrasion resistance | 100 | 130 | 100 | 129 | 100 | 132 | 100 | 115 | 100 | 114 |

TABLE 5

| | | Comparative | | Comparative | | Comparative | | |
|---|---|---|---|---|---|---|---|---|
| | | Example 6 | Example 6 | Example 7 | Example 7 | Example 8 | Example 8 | Example 9 |
| Steps (I) | Natural rubber latex | 100 | 100 | 100 | 100 | 100 | 100 | 100 |
| to (III) | (solid content therein) | | | | | | | |
| | Carbon-black-containing aqueous-slurry- | | | | | | | |
| | solution 1 (solid content therein) | | | | | | | |
| | Carbon-black-containing aqueous-slurry- | | 40 | | | | | |
| | solution 2 (solid content therein) | | | | | | | |
| | Carbon-black-containing aqueous-slurry- | | | | 40 | | | |
| | solution 3 (solid content therein) | | | | | | | |
| | Carbon-black-containing aqueous-slurry- | | | | | | 40 | |
| | solution 4 (solid content therein) | | | | | | | |
| | Carbon-black-containing aqueous-slurry- | | | | | | | 40 |
| | solution 5 (solid content therein) | | | | | | | |
| | Carbon-black-containing aqueous-slurry- | | | | | | | |
| | solution A (solid content therein) | | | | | | | |
| | Carbon-black-containing aqueous-slurry- | 40 | | | | | | |
| | solution B (solid content therein) | | | | | | | |
| | Carbon-black-containing aqueous-slurry- | | | 40 | | | | |
| | solution C | | | | | | | |
| | (solid content therein) | | | | | | | |
| | Carbon-black-containing aqueous-slurry- | | | | | 40 | | |
| | solution D | | | | | | | |
| | (solid content therein) | | | | | | | |
| Steps (IV) | zinc oxide | 1 | 1 | 1 | 1 | 1 | 1 | 1 |
| | Stearic acid | 2 | 2 | 2 | 2 | 2 | 2 | 2 |
| | Wax | 1 | 1 | 1 | 1 | 1 | 1 | 1 |
| | Antiaging agent (A) | 2 | 2 | 2 | 2 | 2 | 2 | 2 |
| | Antiaging agent (B) | 1 | 1 | 1 | 1 | 1 | 1 | 1 |
| | Sulfur | 2 | 2 | 2 | 2 | 2 | 2 | 2 |
| | Vulcanization promoter | 1 | 1 | 1 | 1 | 1 | 1 | 1 |
| Evaluations | Exothermicity | 100 | 99 | 100 | 98 | 100 | 100 | 99 |
| | Abrasion resistance | 100 | 133 | 100 | 131 | 100 | 120 | 114 |

Hereinafter, embodiments related to the third object will be described.

### <Preparation of Carbon-Black-Containing Aqueous-Slurry-Solutions>

### Preparation Example 1

To water was added a carbon black (SEAST SO (FEF), manufactured by Tokai Carbon Co., Ltd.; nitrogen adsorption specific surface area: 42 m²/g), and then a “High Shear Mixer” manufactured by Silverson Machines, Inc. was used to disperse the carbon black in water (High Shear Mixer conditions: its work head (stator) was a slot type head (slot interval: 3 mm); the rotation number thereof was 3,600 rpm; the treating period was 30 minutes; and the treating temperature was 50° C.) to prepare a carbon-black-containing aqueous-slurry-solution 1 having a carbon black concentration of 10% by weight.

### Preparation Example 2

A carbon-black-containing aqueous-slurry-solution 2 was prepared by the same operations as in Preparation Example 1 except that in Preparation Example 1 the species of the carbon black was changed to a carbon black (“SEAST V (GPF) manufactured by Tokai Carbon Co., Ltd.; nitrogen adsorption specific surface area: 27 m²/g).

### Preparation Example 3

A carbon-black-containing aqueous-slurry-solution 3 was prepared by the same operations as in Preparation Example 1 except that in Preparation Example 1 the species of the carbon black was changed to a carbon black (“SEAST 3 (HAF) manufactured by Tokai Carbon Co., Ltd.; nitrogen adsorption specific surface area: 79 m²/g).

### Preparation Example 4

A carbon-black-containing aqueous-slurry-solution 4 was prepared by the same operations as in Preparation Example 1 except that in Preparation Example 1 the species of the carbon black was changed to a carbon black (“SEAST 6 (ISAF) manufactured by Tokai Carbon Co., Ltd.; nitrogen adsorption specific surface area: 119 m²/g).

### Preparation Example 5

A carbon-black-containing aqueous-slurry-solution 5 was prepared by the same operations as in Preparation Example 1 except that in Preparation Example 1 the treating period was changed to 10 minutes.

### Comparative Preparation Example A

A carbon-black-containing aqueous-slurry-solution A was prepared by the same operations as in Preparation Example 1 except that in Preparation Example 1, the work head (stator) was changed from the slot type head (slot interval: 3 mm) to a round work head (circle diameter: 10 mm).

### Comparative Preparation Example B

A carbon-black-containing aqueous-slurry-solution B was prepared by the same operations as in Preparation Example 2 except that in Preparation Example 2, the work head (stator) was changed from the slot type head (slot interval: 3 mm) to a round work head (circle diameter: 10 mm).

### Comparative Preparation Example C

A carbon-black-containing aqueous-slurry-solution C was prepared by the same operations as in Preparation Example 3 except that in Preparation Example 3, the work head (stator) was changed from the slot type head (slot interval: 3 mm) to a round work head (circle diameter: 10 mm).

### Comparative Preparation Example D

A carbon-black-containing aqueous-slurry-solution D was prepared by the same operations as in Preparation Example 4 except that in Preparation Example 4, the work head (stator) was changed from the slot type head (slot interval: 3 mm) to a round work head (circle diameter: 10 mm).

### <Evaluation of Carbon Black Particles Contained in Each of Carbon-Black-Containing Aqueous-Slurry-Solutions>

Water was added to the carbon-black-containing aqueous-slurry-solution yielded in each of Preparation Examples 1 to 5 and Comparative Preparation Examples A to D to dilute the solution to prepare a carbon black dispersion having a concentration of 0.005% by weight. Next, the following were gained, using an image-analytic particle size distribution meter (“IF-3200”, manufactured by JASCO International Co., Ltd.; analyzing software: “PIA-Pro Image Analyzing Software ver. 2016 under measuring conditions that the cell thickness was 50 μm, the sample concentration was 0.005% by weight, and the number of cumulative particles to be analyzed was from 15,000 to 30,000): the proportion of carbon black particles having a particle diameter of 60 μm or more therein; and the D90, D70, D50, and D10 of the carbon black particles. The results are shown in Table 6.

TABLE 6

| | Carbon-black-containing aqueous-slurry-solutions | | | | | | | | |
|---|---|---|---|---|---|---|---|---|---|
| | 1 | 2 | 3 | 4 | 5 | A | B | C | D |
| Carbon black | SEAST | SEAST V | SEAST 3 | SEAST 6 | SEAST | SEAST | SEAST V | SEAST 3 | SEAST 6 |
| | SO | | | | SO | SO | | | |
| Proportion (% by | 10 | 10 | 11 | 10 | 30 | 40 | 40 | 43 | 40 |
| volume) of | | | | | | | | | |
| carbon black | | | | | | | | | |
| particles | | | | | | | | | |
| having particle | | | | | | | | | |
| diameter of 60 μm | | | | | | | | | |
| or more | | | | | | | | | |
| 10%-by-volume | 5 | 4 | 4 | 5 | 8 | 9 | 8 | 9 | 9 |
| particle | | | | | | | | | |
| diameter | | | | | | | | | |
| (μm) | | | | | | | | | |
| 50%-by-volume | 12 | 11 | 10 | 10 | 32 | 54 | 54 | 55 | 53 |
| particle | | | | | | | | | |
| diameter | | | | | | | | | |
| (μm) | | | | | | | | | |
| 70%-by-volume | 15 | 14 | 13 | 13 | 60 | 80 | 81 | 80 | 79 |
| particle | | | | | | | | | |
| diameter | | | | | | | | | |
| (μm) | | | | | | | | | |
| 90%-by-volume | 60 | 60 | 60 | 60 | 113 | 115 | 117 | 115 | 116 |
| particle | | | | | | | | | |
| diameter | | | | | | | | | |
| (μm) | | | | | | | | | |

(Used Materials Other Than Carbon Black)

a) Natural rubber latex solution: “NR field latex” (manufactured by a company Golden Hope) (DRC=31.2%);
b) Zinc oxide: “Zinc Oxide, species 3” (manufactured by Mitsui Mining & Smelting Co., Ltd.);
c) Stearic acid: “RUNACK S-20” (manufactured by Kao Corp.);
d) Wax: “OZOACE 0355” (manufactured by Nippon Seiro Co., Ltd.);
e) Antiaging agent (A): “NOCRAC 6C” (manufactured by Ouchi Shinko Chemical Industrial Co., Ltd.;
f) Antiaging agent (B): Polymerized-2,2,4-trimethyl-1,2-dihydroquinoline (ANTAGE RD, manufactured by Kawaguchi Chemical Industry Co., LTD.);
j) Sulfur: “5%-OIL-INCORPORATED FINELY-POWDERY SULFUR” (manufactured by Tsurumi Chemical Industry Co., Ltd.); and
h) Vulcanization promoter: N-tert-butyl-2-benzothiazolylsulfenamide: “NOCCELLAR NS-P” (manufactured by Ouchi Shinko Chemical Industrial Co., Ltd.).

### Example 1

### <Step (I): Production of Carbon-Black-Containing Aqueous-Rubber-Latex-Solution>

A natural rubber latex solution (25% by weight) was added, at ambient temperature, into the carbon-black-containing aqueous-slurry-solution 1 yielded through the above-mentioned step to give a solid content (rubber component) of 100 parts by weight for 30 parts by weight of the carbon black. Next, a mixer (Super Mixer SMV-20) manufactured by Kawata Mfg. Co., Ltd. was used to mix the existing components with each other to prepare a carbon-black-containing aqueous-rubber-latex-solution.

### <Step (II): Production of Carbon-Black-Containing Rubber Solidified Product>

Subsequently, while the mixer (Super Mixer SMV-20) manufactured by Kawata Mfg. Co., Ltd. was used to blend formic acid (10% solution) as a solidifier into the carbon-black-containing aqueous-rubber-latex-solution (90° C.) produced in the step (I), the solidifier was added to the solution until the pH of the whole of the solution turned into 4. In this way, a carbon-black-containing rubber solidified product was produced (step (II)).

### <Step (III): Production of Rubber Wet Masterbatch>

A squeezer type uniaxial extruding/dehydrating machine (V-02 type, manufactured by Suehiro EPM Corp.) was used to dehydrate and dry the carbon-black-containing rubber solidified product produced in the step (II) until the water content therein turned to 1.5% or less. In this way, a rubber wet masterbatch was produced (step (III)).

### <Step (IV): Production of Rubber Composition and Unvulcanized Rubber Composition>

A Banbury mixer was used to dry-mix the rubber wet masterbatch yielded through the above-mentioned steps with individual materials (other than any sulfur and any vulcanization promoter) shown in Table 7 (kneading period: 3 minutes; composition-discharging-temperature: 150° C.). In this way, a rubber composition was produced. Next, to the resultant rubber composition were added sulfur and a vulcanization promoter shown in Table 7, and then the Banbury mixer was used to dry-mix all the components (kneading period: 1 minute; composition-discharging-temperature: 90° C.). In this way, an unvulcanized rubber composition was produced. The blend proportion of any component in Table 7 is represented by the numerical value (phr) of the part(s) by weight of this component when the whole amount of the rubber component contained in the corresponding rubber composition is regarded as 100 parts by weight.

### Examples 2 to 9, and Comparative Examples 1 to 8

A rubber wet masterbatch, a rubber composition and an unvulcanized rubber composition of each of Examples 2 to 9 and Comparative Examples 1 to 8 were produced in the same way as in Example 1 except that in the item <Step (I): Production of Carbon-Black-Containing Aqueous-Rubber-Latex-Solution> in Example 1, the used carbon-black-containing aqueous-slurry-solution was changed to one shown in Table 6, and in the item <Step (IV): Production of Rubber Composition and Unvulcanized Rubber Composition>, the respective blend amounts of the used materials were changed as shown in Table 7 or 8.

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 7 or 8.

### <Evaluation of Tear Resistance>

About the evaluation of the tear resistance of each of the examples, the vulcanized rubber yielded through the above-mentioned steps was punched out into a crescent form prescribed in JIS K6252, and then a notch of 0.50±0.08 mm was made at a center of a depression of the resultant to yield a sample. A tension tester manufactured by Shimadzu Corp. was used to measure the tear strength of the sample at a tension rate of 500 mm/minute. The tear strength in each of Examples 1 and 9 was represented by an index relative to the value regarded as 100 in Comparative Example 1; that in Example 2, by an index relative to the value regarded as 100 in Comparative Example 2; that in Example 3, by an index relative to the value regarded as 100 in Comparative Example 3; that in Example 4, by an index relative to the value regarded as 100 in Comparative Example 4; that in Example 5, by an index relative to the value regarded as 100 in Comparative Example 5; that in Example 6, by an index relative to the value regarded as 100 in Comparative Example 6; that in Example 7, by an index relative to the value regarded as 100 in Comparative Example 7; and that in Example 8, by an index relative to the value regarded as 100 in Comparative Example 8. It is demonstrated that as the examples are larger in index, the examples are better in tear resistance.

### <Evaluation of Fatigue Resistance>

About the evaluation of the fatigue resistance of each of the examples, in accordance with JIS K6260, a Demattia flex cracking tester was used to measure the number of times of the flexing until a crack was generated in a sample of the example. The value in each of Examples 1 and 9 was represented by an index relative to the value regarded as 100 in Comparative Example 1; that in Example 2, by an index relative to the value regarded as 100 in Comparative Example 2; that in Example 3, by an index relative to the value regarded as 100 in Comparative Example 3; that in Example 4, by an index relative to the value regarded as 100 in Comparative Example 4; that in Example 5, by an index relative to the value regarded as 100 in Comparative Example 5; that in Example 6, by an index relative to the value regarded as 100 in Comparative Example 6; that in Example 7, by an index relative to the value regarded as 100 in Comparative Example 7; and that in Example 8, by an index relative to the value regarded as 100 in Comparative Example 8. It is demonstrated that as the examples are larger in index, the examples are better in fatigue resistance.

TABLE 7

| | | Com- | | Com- | | Com- | | | | | |
|---|---|---|---|---|---|---|---|---|---|---|---|
| | | parative | Ex- | parative | Ex- | parative | Ex- | Comparative | Ex- | Comparative | Ex- |
| | | Example 1 | ample 1 | Example 2 | ample 2 | Example 3 | ample 3 | Example 4 | ample 4 | Example 5 | ample 5 |
| Steps | Natural rubber latex | 100 | 100 | 100 | 100 | 100 | 100 | 100 | 100 | 100 | 100 |
| (I) to | (solid content therein) | | | | | | | | | | |
| (III) | Carbon-black-containing | | 30 | | 25 | | 40 | | 20 | | 50 |
| | aqueous-slurry-solution 1 | | | | | | | | | | |
| | (solid content therein) | | | | | | | | | | |
| | Carbon-black-containing | | | | | | | | | | |
| | aqueous-slurry-solution 2 | | | | | | | | | | |
| | (solid content therein) | | | | | | | | | | |
| | Carbon-black-containing | | | | | | | | | | |
| | aqueous-slurry-solution 3 | | | | | | | | | | |
| | (solid content therein) | | | | | | | | | | |
| | Carbon-black-containing | | | | | | | | | | |
| | aqueous-slurry-solution 4 | | | | | | | | | | |
| | (solid content therein) | | | | | | | | | | |
| | Carbon-black-containing | | | | | | | | | | |
| | aqueous-slurry-solution 5 | | | | | | | | | | |
| | (solid content therein) | | | | | | | | | | |
| | Carbon-black-containing | 30 | | 25 | | 40 | | 20 | | 50 | |
| | aqueous-slurry-solution A | | | | | | | | | | |
| | (solid content therein) | | | | | | | | | | |
| | Carbon-black-containing | | | | | | | | | | |
| | aqueous-slurry-solution B | | | | | | | | | | |
| | (solid content therein) | | | | | | | | | | |
| | Carbon-black-containing | | | | | | | | | | |
| | aqueous-slurry-solution C | | | | | | | | | | |
| | (solid content therein) | | | | | | | | | | |
| | Carbon-black-containing | | | | | | | | | | |
| | aqueous-slurry-solution D | | | | | | | | | | |
| | (solid content therein) | | | | | | | | | | |
| Steps | zinc oxide | 1 | 1 | 1 | 1 | 1 | 1 | 1 | 1 | 1 | 1 |
| (IV) | Stearic acid | 2 | 2 | 2 | 2 | 2 | 2 | 2 | 2 | 2 | 2 |
| | Wax | 1 | 1 | 1 | 1 | 1 | 1 | 1 | 1 | 1 | 1 |
| | Antiaging agent (A) | 2 | 2 | 2 | 2 | 2 | 2 | 2 | 2 | 2 | 2 |
| | Antiaging agent (B) | 1 | 1 | 1 | 1 | 1 | 1 | 1 | 1 | 1 | 1 |
| | Sulfur | 2 | 2 | 2 | 2 | 2 | 2 | 2 | 2 | 2 | 2 |
| | Vulcanization promoter | 1 | 1 | 1 | 1 | 1 | 1 | 1 | 1 | 1 | 1 |
| Eval- | Tear resistance | 100 | 120 | 100 | 120 | 100 | 119 | 100 | 115 | 100 | 116 |
| uations | Fatigue resistance | 100 | 123 | 100 | 122 | 100 | 122 | 100 | 115 | 100 | 114 |

TABLE 8

| | | Comparative | | Comparative | | Comparative | | |
|---|---|---|---|---|---|---|---|---|
| | | Example 6 | Example 6 | Example 7 | Example 7 | Example 8 | Example 8 | Example 9 |
| Steps (I) | Natural rubber latex | 100 | 100 | 100 | 100 | 100 | 100 | 100 |
| to (III) | (solid content therein) | | | | | | | |
| | Carbon-black-containing aqueous-slurry- | | | | | | | |
| | solution 1 (solid content therein) | | | | | | | |
| | Carbon-black-containing aqueous-slurry- | | 30 | | | | | |
| | solution 2 (solid content therein) | | | | | | | |
| | Carbon-black-containing aqueous-slurry- | | | | 30 | | | |
| | solution 3 (solid content therein) | | | | | | | |
| | Carbon-black-containing aqueous-slurry- | | | | | | 30 | |
| | solution 4 (solid content therein) | | | | | | | |
| | Carbon-black-containing aqueous-slurry- | | | | | | | 30 |
| | solution 5 (solid content therein) | | | | | | | |
| | Carbon-black-containing aqueous-slurry- | | | | | | | |
| | solution A (solid content therein) | | | | | | | |
| | Carbon-black-containing aqueous-slurry- | 30 | | | | | | |
| | solution B (solid content therein) | | | | | | | |
| | Carbon-black-containing aqueous-slurry- | | | 30 | | | | |
| | solution C | | | | | | | |
| | (solid content therein) | | | | | | | |
| | Carbon-black-containing aqueous-slurry- | | | | | 30 | | |
| | solution D | | | | | | | |
| | (solid content therein) | | | | | | | |
| Steps (IV) | zinc oxide | 1 | 1 | 1 | 1 | 1 | 1 | 1 |
| | Stearic acid | 2 | 2 | 2 | 2 | 2 | 2 | 2 |
| | Wax | 1 | 1 | 1 | 1 | 1 | 1 | 1 |
| | Antiaging agent (A) | 2 | 2 | 2 | 2 | 2 | 2 | 2 |
| | Antiaging agent (B) | 1 | 1 | 1 | 1 | 1 | 1 | 1 |
| | Sulfur | 2 | 2 | 2 | 2 | 2 | 2 | 2 |
| | Vulcanization promoter | 1 | 1 | 1 | 1 | 1 | 1 | 1 |
| Evaluations | Tear resistance | 100 | 121 | 100 | 119 | 100 | 113 | 114 |
| | Fatigue resistance | 100 | 122 | 100 | 121 | 100 | 114 | 112 |

What is claimed is:

1. A method for producing a rubber wet masterbatch, comprising:
a step (I) of mixing a carbon-black-containing aqueous-slurry-solution in which a carbon black is dispersed in water with a rubber latex solution to produce a carbon-black-containing aqueous-rubber-latex-solution,
a step (II) of solidifying the resultant carbon-black-containing aqueous-rubber-latex-solution to produce a carbon-black-containing rubber solidified product, and
a step (III) of dehydrating and drying the resultant carbon-black-containing rubber solidified product to produce the rubber wet masterbatch,
wherein about the carbon-black-containing aqueous-slurry-solution, in carbon black particles in the slurry-solution, a proportion of carbon black particles having a particle diameter of 60 μm or more is 35% or less by volume, the particle diameter being based on a measurement of the carbon black particles in the slurry-solution with an image-analytic particle size distribution meter.

2. The method for producing a rubber wet masterbatch according to claim 1, wherein about the carbon-black-containing aqueous-slurry-solution, the carbon black particles in the slurry-solution have a 90%-by-volume particle diameter (D90) of 30 to 120 μm both inclusive, the D90 being based on the measurement with the image-analytical particle size distribution meter.

3. The method for producing a rubber wet masterbatch according to claim 1, wherein about the carbon-black-containing aqueous-slurry-solution, the carbon black particles in the slurry-solution have a 50%-by-volume particle diameter (D50) of 3 to 60 μm both inclusive, the D50 being based on the measurement with the image-analytical particle size distribution meter.

4. A method for producing a rubber composition, comprising a step (IV) of using the rubber wet masterbatch yielded by the method for producing a rubber wet masterbatch recited in claim 1 to attain dry-mixing.

5. The method for producing a rubber composition according to claim 4, the method is a method for producing a rubber composition for tire treads.

6. The method for producing a rubber composition according to claim 4, the method is a method for producing a rubber composition for ply topping.
